(19) United States
(12) Patent Application Publication
(10) Pub. No.: US 2014/0167436 A1
(43) Pub. Date: Jun. 19, 2014

(54) Adjustable Truck Rack

(71) Applicants: Damon Maxwell, Enumclaw, WA (US); Peter Andonian, Mercer Island, WA (US); Kristina Andonian, Mercer Island, WA (US); Kevin Prchal, Snoqualmie, WA (US)

(72) Inventors: Damon Maxwell, Enumclaw, WA (US); Peter Andonian, Mercer Island, WA (US); Kristina Andonian, Mercer Island, WA (US); Kevin Prchal, Snoqualmie, WA (US)

(21) Appl. No.: 14/028,491

(22) Filed: Sep. 16, 2013

Related U.S. Application Data
(60) Provisional application No. 61/702,131, filed on Sep. 17, 2012.

(51) Int. Cl. B60R 9/06

(52) U.S. Cl. CPC B60R 9/06
USPC 296/3

(57) ABSTRACT

A reversible rear cargo carrying member that is raked at a selectable forward or rear angle with respect to the vertical and which is selectably positioned in one of a plurality of selectable positions along rails of a truck bed.

This application claims priority to U.S. Provisional Application 61/702131 filed Sep. 17, 2012, the contents of which are hereby incorporated by reference.

### BACKGROUND

It is well known to provide a pickup truck with a rack that provides for carrying either additional cargo or specialized cargo on the truck. Conventional truck rack configurations are many and varied. What has not been previously disclosed is providing such a rack with a reversible rear member that is raked at a forward or rear angle to the vertical and which can be selectably positioned in a plurality of positions along bottom rails.

What is needed is a reversible rear member that is raked at a forward or rear angle to the vertical and which can be selectably positioned in a plurality of positions along bottom rails.

### DISCLOSURE

What is disclosed is a modular truck rack that includes a reversible rear member that is raked at a forward or rear angle with respect to the vertical and which can be selectably positioned in a plurality of positions along bottom rails. The rear member is removably attached to a pair of bottom rails which are in turn mounted on the pickup truck. There are selectable attachment points for the rear member along these rails, from nearly the front of the truck bed to the rear of the bed. The rear member may be reversibly installed at any of these selectable points on the rails. In one position, the rear member is raked forward at an angle and provides lower cargo clearance and head clearance not available with an un-raked rear member; in the reversed position, the rear member is raked to the rear at that angle and provides extended length cargo space on top of the rack.

### BRIEF DESCRIPTION OF THE DRAWINGS

FIGS. 1a-b are schematic side views of the cargo member.

### BEST MODE

A rake angle of about 19 degrees with respect to the vertical for the rear member has been found to work very well; other rake angles however in the range of 5 to 45 degrees from the vertical will also serve advantageously, with rake angles in the range of 9 to 34 degrees and 14 to 29 degrees desirable.

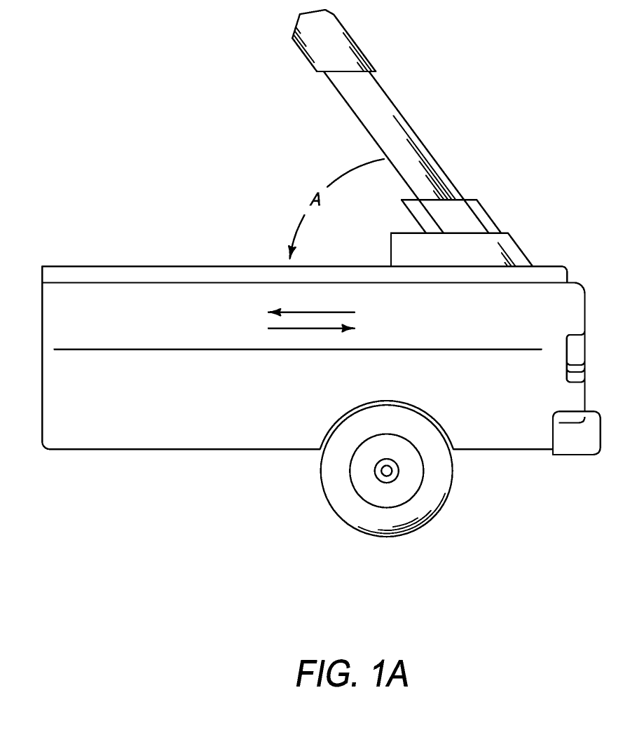

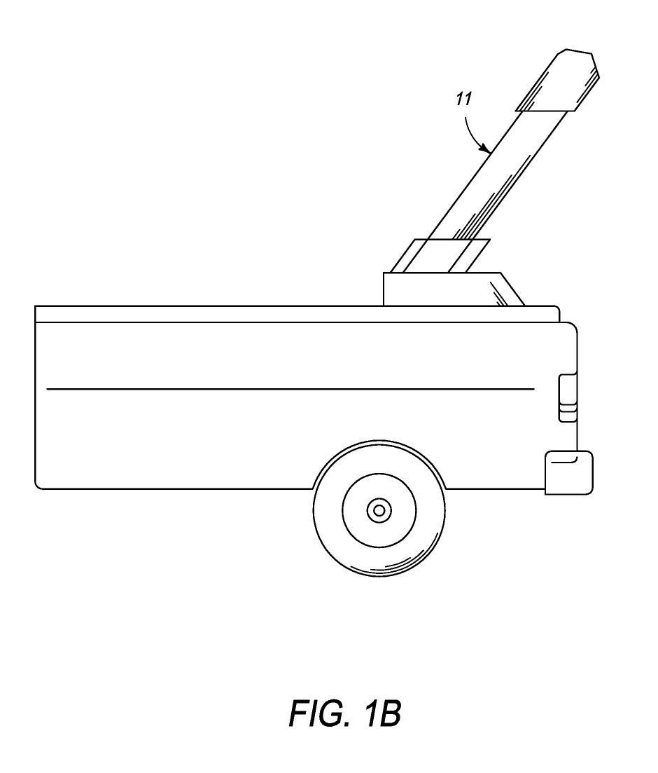

These features are schematically illustrated in FIG. 1. In FIG. 1, rear member 11 is illustrated in both forward rake position and rear rake position, and raked at angle A. Rear member 11 can be positioned near the front of the truck bed or positioned near the rear of the truck bed, as indicated by the double set of arrows, as well as selectable positions in between.

We claim:

1. A reversible rear cargo carrying member that is raked at a selectable forward or rear angle with respect to the vertical and which is selectably positioned in one of a plurality of selectable positions along rails of a truck bed.

2. The apparatus of claim 1 wherein the rear member is removably attached to a pair of bottom rails which are in turn mounted on the pickup truck.

3. The apparatus of claim 1 wherein the selectable rake angle is in the range of 5 to 45 degrees from the vertical.
